(19) United States
(12) Patent Application Publication
(10) Pub. No.: US 2004/0063451 A1
(43) Pub. Date: Apr. 1, 2004

(54) Relaying information within an ad-hoc cellular network

(76) Inventors: Jeffrey D. Bonta, Arlington Heights, IL (US); George Calcev, Hoffman Estates, IL (US)

Correspondence Address: MOTOROLA, INC., 1303 EAST ALGONQUIN ROAD, IL01/3RD, SCHAUMBURG, IL, 60196

(21) Appl. No.: 10/256,788

(22) Filed: Sep. 27, 2002

(51) Int. Cl. H04B 7/00; H04Q 7/20

(52) U.S. Cl. 455/519; 455/518

(57) ABSTRACT

A registration from a subscriber is delivered to the cellular network via an ad hoc network. Based on registration information, several return paths are prepared for delivery of a page from the cellular network to the subscriber regardless of the initial or final coverage state of the subscriber and regardless of the final coverage or operational state of its assigned relays.

### FIELD OF THE INVENTION

The present invention relates generally to cellular networks and in particular, to relaying information within an ad-hoc cellular network.

### BACKGROUND OF THE INVENTION

The delivery of a new incoming call to a cellular subscriber is dependent upon the ability to successfully inform the subscriber of an incoming call. The network equipment must be periodically informed of the location area of an idle mode subscriber with a registration message, typically sent by the subscriber. A registration message informs the network equipment of the availability of the subscriber to receive a page to complete the call.

Knowing the location area of the subscriber, the network uses a page message containing the subscriber's identity to inform the subscriber of the incoming call. In a radio environment, the successful delivery of that registration and page message is impeded by the available RF coverage of the subscriber. For example, the absence of RF coverage is often observed within the center of a building. A mechanism is necessary to insure the delivery of these messages in such environments. One known method utilizes a hybrid of a cellular and ad-hoc network, where the messages between the out-of-coverage subscriber and cellular network are relayed through another subscriber with accessibility to the out-of-coverage subscriber and the network equipment.

As described in the international application published under the Patent Cooperation Treaty, publication number WO 00/54539, ROUTING IN A MULTI-STATION NETWORK, increased coverage reliability and increased throughput are some of the benefits of using ad-hoc networking. In cellular communication systems utilizing ad-hoc networking, cellular handsets are equipped to operate in both the cellular and ad-hoc networks. Users access the cellular infrastructure through the ad-hoc network whenever they cannot access the network equipment directly, or when they find it more advantageous to do so. Using an ad-hoc air interface, such users transmit to another user, which forwards (relays) the transmission to the infrastructure through the cellular air interface. Such a system is shown in FIG. 1.

As shown, remote (or mobile) unit 102 existing within area 101 is unable to communicate directly with infrastructure equipment 106. By utilizing ad-hoc networking, subscriber unit 102 communicates with subscriber unit 104 (via ad-hoc air interface 103). Subscriber unit 104 then relays the communication to infrastructure 106 via air interface 105.

Since a registration and page are separated by an indeterminate time interval (of perhaps many seconds up to the length of the registration period), mobility and configuration changes of subscriber units can cause the prior art to fail to deliver the page message. First, there is no guarantee that subscriber unit 102 will be in the same state of coverage at time of registration and the time of the page. For example, subscriber unit 102 may be within cellular coverage at the time of registration, but out of cellular coverage at the time of the page. Conversely, subscriber unit 102 may be out of cellular coverage at the time of registration and within cellular coverage at the time of the page. Secondly, when a relay is used to deliver the registration, there is no guarantee that the relay will be capable of receiving or delivering the page to the out-of-coverage subscriber. For example, the relay may have powered down. Therefore a need exists for a method and apparatus for relaying information within an ad-hoc cellular network that accounts for mobility and configuration possibilities to insure the successful delivery of the incoming call.

### BRIEF DESCRIPTION OF THE DRAWINGS

FIG. 1 is a block diagram of an ad-hoc communication system.

FIG. 2 is a block diagram of an ad-hoc communication system in accordance with the preferred embodiment of the present invention.

FIG. 3 is a flow chart showing those steps necessary for idle-mobile registration in accordance with the preferred embodiment of the present invention.

FIG. 4 is a block diagram of a mobile unit in accordance with the preferred embodiment of the present invention.

FIG. 5 is a flow chart showing operation of the mobile unit of FIG. 4 in accordance with the preferred embodiment of the present invention.

FIG. 6 is a flow chart showing operation of the infrastructure equipment of FIG. 2 in accordance with the preferred embodiment of the present invention.

FIG. 7 is a flow chart showing operation of a relay device in accordance with the preferred embodiment of the present invention.

FIG. 8 is a block diagram of infrastructure equipment in accordance with the preferred embodiment of the present invention.

FIG. 9 is a flow chart showing operation of infrastructure equipment in accordance with the preferred embodiment of the present invention.

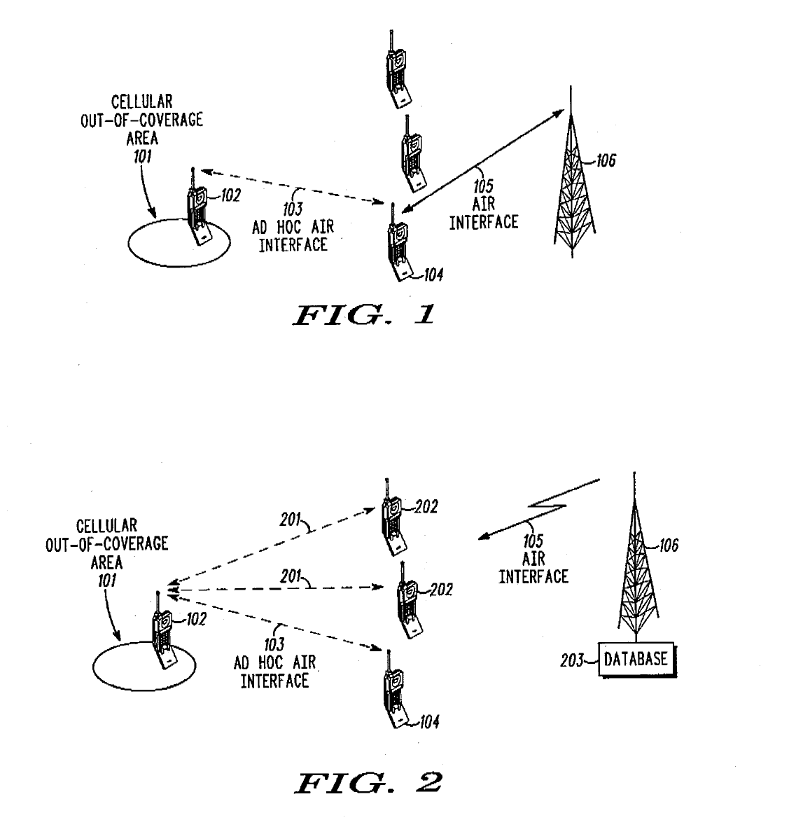

### DETAILED DESCRIPTION OF THE DRAWINGS

To address the above-mentioned need, a method and apparatus for relaying information within an ad-hoc communication system is provided herein. More particularly, an out-of-coverage subscriber proactively obtains knowledge of each immediate neighbor's identification and possible ad-hoc network routes to those neighbors. An initial registration attempt is sent directly to infrastructure equipment as well as to each neighbor to provide them with the out-of-coverage mobile's identification. If a connection could not be established, a registration proxy message containing the registrar's identification is sent to a neighbor subscriber that the routing protocol deems is the desired master relay. The master relay will then register the subscriber.

Regardless of the route, all registrations sent to infrastructure equipment contain the identification of the registering out-of-coverage subscriber and the desired master relay, and may include a list of identities of all possible relays. Network equipment creates an association between the registering subscriber and the reported potential relays, and stores this association. (This association is used in the event that one of the potential relays is assigned to a traffic channel at the time that a page needs to be delivered to the registered subscriber).

When a calling party attempts to call a mobile unit, a page is broadcast on the paging channel containing the identity of the out-of-coverage subscriber. At the time of the page, the page message is delivered both on the paging channel and via the ad-hoc network by all relay nodes. The out-of-coverage subscriber along with each neighbor subscriber that received the out-of-coverage subscriber's registration must monitor the paging channel for a page containing the out-of-coverage subscriber's identification. Once the identification is recognized, the neighbor subscribers will forward the page to the out-of-coverage subscriber via the ad-hoc network. Since this approach provides redundant paths to the out-of-coverage subscriber the chance that a message sent to the subscriber will arrive at the subscriber is greatly increased.

The present invention encompasses a method for relaying information within an ad-hoc network. The method comprises the steps of determining if a first mobile unit has recently been instructed to relay information to/from a second mobile unit, and determining that the first mobile unit will no longer be capable of relaying information to the second mobile unit. Based on the determination that the first mobile unit has recently been instructed to relay, and additionally based on the determination that the first mobile unit will no longer be capable of relaying information, a deregistration message is sent from the first mobile unit to the second mobile unit, causing the second mobile unit to reregister with infrastructure equipment.

The present invention additionally encompasses a method for relaying information within an ad-hoc network. The method comprises the steps of receiving a message from a second mobile unit relayed through a first mobile unit via an ad-hoc air interface, determining that information needs to be transmitted to the second mobile unit, and determining if the first mobile unit is currently utilizing a traffic channel. The information is transmitted to the first mobile unit to be relayed to the second mobile unit. The information is transmitted over the traffic channel if the first mobile unit is currently utilizing the traffic channel, otherwise the information is transmitted over a paging channel.

The present invention additionally encompasses a mobile unit comprising a receiver having information destined to a second mobile unit as an input, a transmitter outputting the information to the second mobile unit, and logic circuitry, determining if the mobile unit is about to power down, and notifying the second mobile unit when the mobile unit is about to power down.

Finally, the present invention encompasses infrastructure equipment comprising a receiver receiving a message from a second mobile unit relayed through a first mobile unit via an ad-hoc air interface, logic circuitry determining that information needs to be transmitted to the second mobile unit, the logic circuitry additionally determining if the first mobile unit is currently utilizing a traffic channel, and transmitting circuitry outputting the information to the first mobile unit to be relayed to the second mobile unit; wherein the information is transmitted over the traffic channel if the first mobile unit is currently utilizing the traffic channel, otherwise the information is transmitted over a paging channel.

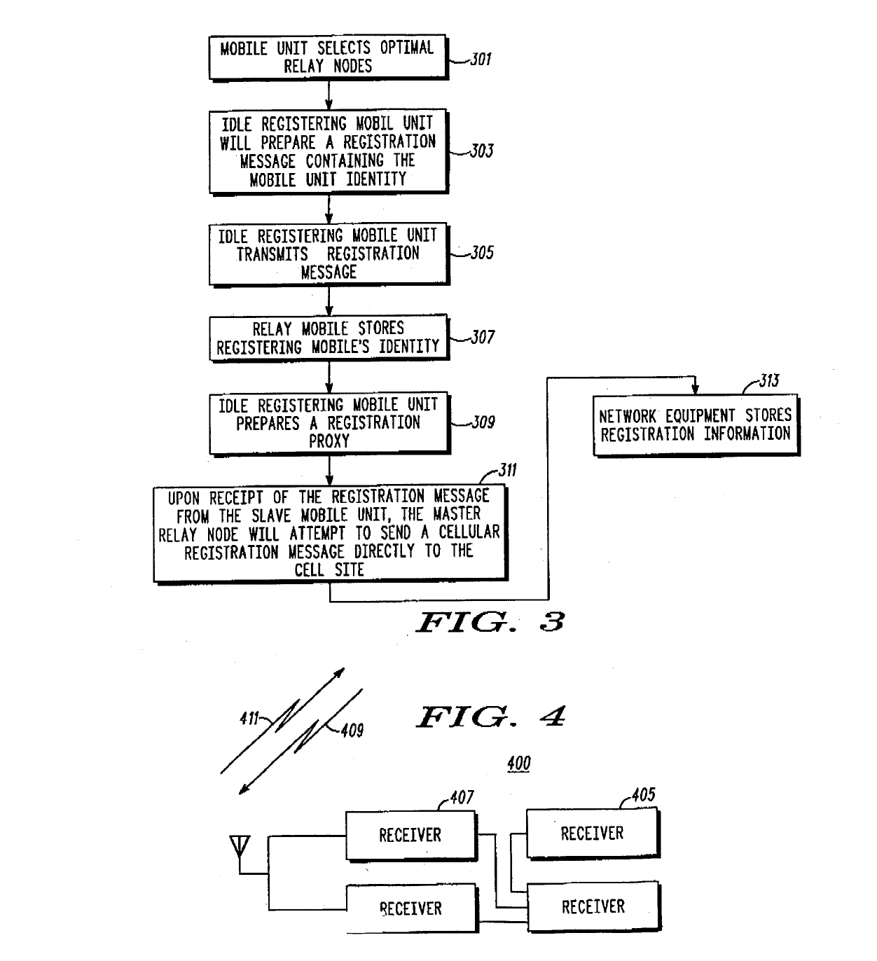

Turning now to the drawings, wherein like numerals designate like components, FIG. 2 is a block diagram of an ad-hoc network in accordance with the preferred embodiment of the present invention. As is evident, multiple redundant relays 201 are now forwarded to mobile unit 102 or infrastructure equipment 106 by mobile units 202. While infrastructure equipment 106 may use any cellular over-the-air protocol, in the preferred embodiment of the present invention network equipment 106 utilizes a Code Division, Multiple Access protocol such as the next generation CDMA system protocol as described in the cdma2000 International Telecommunication Union-Radiocommunication (ITU-R) Radio Transmission Technology (RTT) Candidate Submission document. Additionally, the ad-hoc network may use any short range communication system protocol, such as, but not limited to a Bluetooth system protocol, an 802.11 system protocol, . . . , etc.

Communication system 100 includes a number of network elements (not shown) such as base stations, Centralized Base Station Controllers (CBSCs), Mobile Switching Centers (MSCs) and the like. In the preferred embodiment of the present invention, all network elements are available from Motorola, Inc. (Motorola Inc. is located at 1301 East Algonquin Road, Schaumburg, Ill. 60196). It is contemplated that network elements within network equipment 106 are configured in well known manners with processors, memories, instruction sets, and the like, which function in any suitable manner to perform the function set forth herein.

Out-of-Coverage Subscriber Registers when in a Coverage Hole

FIG. 3 is a flow chart showing those steps necessary for idle-mobile registration in accordance with the preferred embodiment of the present invention. Knowing the need to register, mobile unit 102 must first select the optimal relay node that provides the best route to a infrastructure equipment 106 and associate itself with that relay node by becoming its slave (step 301). It is assumed that mobile unit 102 has proactively participated in the ad-hoc (e.g., Bluetooth, 802.11, . . . , etc.) query procedures to find all possible ad-hoc networking routes to relay nodes that have coverage with the infrastructure equipment 106. In the event that at least one ad-hoc networking route to a relay has been identified, the out-of-coverage mobile unit at step 303 will prepare a registration message containing its identity (International Mobile Station Identity (IMSI) or Temporary Mobile Station Identity (TMSI)). Having synchronized with each possible relay node, the out-of-coverage mobile unit transmits a registration message (step 305) using an ad-hoc networking frame at the prescribed timeslot designated by the relay node.

In the event that a relay node receives a registration message, the relay node stores the mobile identity of the registering mobile unit and adds this identity (IMSI or TMSI) to the relay node's list of IMSI/TMSI to watch for in page messages (step 307). In other words, the relay node must monitor the paging channel for its own IMSI/TMSI as well as for all others contained in this list.

The out-of-coverage subscriber that needs to register must now consider whether coverage exists to enable registration directly with infrastructure equipment 106. If no coverage exists, and an optimal relay node was selected then the out-of-coverage mobile unit will prepare a registration proxy message containing the mobile unit mobile identity (step 309). The registration message may also contain the identification of the identified master relay node or a list of all all possible relay nodes. Having synchronized with the master relay node, the out-of-coverage mobile unit transmits a registration proxy message to the master relay node using a ad-hoc relay frame at the prescribed timeslot designated by the master. The out-of-coverage mobile unit must then wait for an acknowledgement from infrastructure equipment 106 through a relay.

Upon receipt of the registration message from the slave mobile unit, all relay nodes will attempt to send a cellular registration message directly to infrastructure equipment 106 (step 311). This registration message will include the mobile identity (IMSI or TMSI) of the out-of-coverage mobile unit embedded within it's own LOCATION UPDATE message. The registration message may also contain the IMSI or TMSI of the identified master relay node or a list of all IMSI/TMSI from all possible relay nodes. The relay nodes will wait for an acknowledgement of the registration from infrastructure equipment 106. The call processing state of the relays dictates how this registration is sent to infrastructure equipment 106.

a) If the call processing state the relay is also idle, it will create a registration for delivery via the cellular access channel (RACH).

b) If the call processing state of the relay is conversation (i.e. it already has a traffic channel assignment), then a unique registration message will be prepared for delivery via the traffic channel.

When infrastructure equipment 106 receives the registration message, it will record the registration information in database 203 (step 313). The mobile identity of the registering mobile unit will identify the primary route or address that a future page can be delivered to. Database 203 creates an association of each relay node with the out-of-coverage mobile unit so that a future page for this out-of-coverage mobile unit could be delivered through a relay node's traffic channel in the event that the relay node was involved in a call. Infrastructure equipment 106 will reply to the relay nodes with a registration acknowledgement.

If the relay nodes receives a registration acknowledge from infrastructure equipment 106, they must encapsulate the message in an ad-hoc signaling frame and send it to the out-of-coverage mobile unit. In addition, all nodes will record the fact that it is actively serving a registered mobile unit with the understanding that it is responsible to the registered mobile unit for configuration changes. In the preferred embodiment of the present invention, the responsibility of the relay node to the registered mobile unit is only for the duration of the registration period, so a timer of this event must also be recorded. If the out-of-coverage mobile unit receives the registration acknowledgement, it must reset its registration timer to prepare for the next registration. At this point, the registration procedure is complete and the out-of-coverage subscriber is ready for a page/incoming call.

As discussed above, since a registration and page are separated by an indeterminate time interval (of perhaps many seconds up to the length of the registration period), mobility and configuration changes of subscriber units can cause the prior art to fail to deliver the page message. First, there is no guarantee that subscriber unit 102 will be in the same state of coverage at time of registration and the time of the page. For example, subscriber unit 102 may be with cellular coverage at the time of registration, but without cellular coverage at the time of the page. Conversely, subscriber unit 102 may be without cellular coverage at the time of registration and within cellular coverage at the time of the page. Secondly, when a relay is used to deliver the registration, there is no guarantee that the relay will be capable of receiving or delivering the page to the out-of-coverage subscriber either. The following discussion details how the communication system of FIG. 2 alleviates the above-mentioned problems.

Relay of Idle-Registered Mobile Powers Down

In this scenario, a mobile relay node has recently provided a relay for an out-of-coverage subscriber (mobile unit) that needed to register with infrastructure equipment 106. In the preferred embodiment of the present invention the out-of-coverage subscriber is an ad-hoc relay slave and is dependant on its master relay node for a possible page to set up a new call. However, this master relay node is about to power down. This action may leave the idle slave mobile unit without the ability to receive a page. To improve the reliability of call completions, the following steps are performed prior to powering down, and illustrated with reference to FIG. 4 and FIG. 5.

FIG. 4 is a block diagram of mobile unit 400 in accordance with the preferred embodiment of the present invention. As shown, mobile unit 400 comprises transmitter 401, receiver 407, buffer 405, and logic circuitry 403. As discussed above, transmitter 401 and receiver 407 are designed to operate over both a cellular air interface (e.g., GSM, CDMA, WCDMA, . . . , etc.) and an ad-hoc networking air interface (e.g., BLUETOOTH, 802.11, . . . , etc.). As one of ordinary skill in the art will recognize, the cellular air interface (utilizing a cellular over-the-air protocol) typically serves long-range communication, while the ad-hoc air interface (utilizing an ad-hoc over-the-air protocol) serves short-range communication.

While remote unit 400 is acting as a relay, it is continuously receiving transmissions 409 (via receiver 407) from another remote unit utilizing the ad-hoc air interface and relays (prior to, or after, buffering via buffer 405) these transmissions to infrastructure equipment via transmitter 401 and uplink communication signal 411 utilizing the cellular air interface. Similarly, during relay operations, remote unit 400 is receiving transmissions from infrastructure equipment 106 over the cellular network, and relaying them to a second remote unit via the ad-hoc network. When remote unit 400 is relaying communication through another remote, or mobile unit, remote unit 400 is generally receiving downlink communications and transmitting uplink communications to another remote unit via the ad-hoc air interface.

When remote unit 400 is acting as a relay node, and makes a determination that it will no longer be capable of relaying information (due to a power down, low battery, . . . , etc.), logic unit 403 must determine if it had recently acted as a relay for one or more slave mobile unit (step 501). In particular, a determination is made by logic unit 403 if the mobile unit has recently been instructed to relay information to/from a second mobile unit. If, at step 501, logic unit 403 determines that it has recently provided a registration relay, the logic flow continues to step 503 where the relay node sends a deregistration notification (via transmitter 401) to all slave mobiles unit to inform them that they must reregister their existence with infrastructure equipment 106. The logic flow continues to step 505. However, if, at step 501, logic unit 403 determines that it has not recently provided a registration, the logic flow simply continues to step 505, where remote unit 400 powers down. In the preferred embodiment of the present invention, when a slave mobile unit receives a deregistration notification, the slave mobile unit must start the registration procedure defined above when no further relays exist. This will cause network equipment 106 to remove the powered down mobile from the list of potential relays for mobile unit 102.

Relay Not Responding to Idle-Registered Mobile

This scenario is viewed from the perspective of an out-of-coverage subscriber that previously registered with infrastructure equipment 106 through a relay node that served as the out-of-coverage subscriber's master. This scenario may occur if a relay moves and no longer has a communication path with the out-of-coverage subscriber. In this scenario, the out-of-coverage subscriber must actively search for a new master. Hopefully this out-of-coverage subscriber is already parked under another relay to facilitate a quick recovery. That assumes a proactive routing protocol. In a reactive routing protocol, the search must begin quickly to minimize the chance of a missed page. In either case, this scenario may precipitate the need for a new registration if the newly selected relay node was not previously known. Otherwise, no action is required since the relay node would have already received a registration from the out-of-coverage subscriber.

Registered Out-of-Coverage Subscriber Not Responding to Relay

This scenario is viewed from the perspective of a relay node that has recently provided a relay for an out-of-coverage subscriber that needed to register with infrastructure equipment 106. This scenario may occur if a relay node moves and no longer has a communication path with an out-of-coverage subscriber unit. The relay node has no responsibility in this case to correct this situation. Rather, the out-of-coverage subscriber unit must initiate its own action as defined above. The relay node will remove its record of being a page relay for the registered mobile unit and will no longer monitor for pages belonging to the out-of-coverage subscriber since they cannot be delivered.

Mobile Paged—Relay Available

This common scenario occurs each time a calling party attempts to call a mobile unit with mobile identity belonging to a recently registered out-of-coverage subscriber. The registered out-of-coverage subscriber previously registered with one or more relay nodes that have a direct communication path with network equipment 106. In order to locate the mobile unit, a paging procedure must be invoked to locate mobile unit 102 either directly via the cellular air interface or indirectly through a relay node. With this in mind, there exists several scenarios that can exist, namely:

A mobile unit that receives the page may be the intended out-of-coverage subscriber that previously registered from a coverage hole;

A mobile unit that receives the page from the paging channel may be a relay node that registered this out-of-coverage subscriber unit as a registration proxy; and

One mobile unit that receives the page may be an active mobile on its own traffic channel and was serving as a relay node and a registration proxy for this out-of-coverage subscriber unit.

Each of these scenarios will be addressed separately.

Paged Mobile not in a Coverage Hole

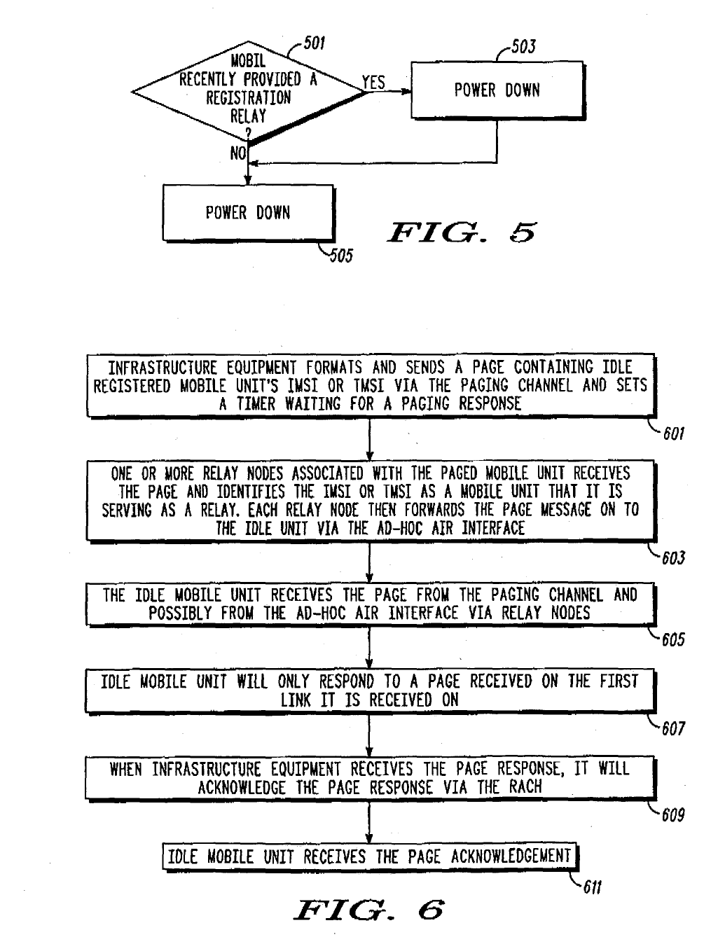

In this scenario, network equipment 106 receives a request to connect an incoming call with a mobile unit that had previously registered the mobile unit's identity and associated location area with network equipment 106 as well as with the mobile unit's local ad-hoc network containing one or more relay nodes. The registered mobile unit is not in a coverage hole during this scenario. This request to connect will initiate a paging procedure for mobile unit 102. The scenario unfolds as follows, and is illustrated in FIG. 6.

At step 601, infrastructure equipment 106 formats and sends a page containing out-of-coverage subscriber unit's IMSI or TMSI via the paging channel and sets a timer waiting for a paging response. At step 603 one or more relay nodes associated with the paged mobile unit receives the page message and identifies the IMSI or TMSI as a mobile unit that it is serving as a relay. Each relay node then forwards the page message on to the out-of-coverage subscriber via the ad-hoc relay air interface. At step 605 the out-of-coverage subscriber receives the page from the paging channel and possibly from the ad-hoc relay air interface via relay nodes. In the preferred embodiment of the present invention the out-of-coverage subscriber will only respond to a page received on the first link it is received on (step 607). Assuming the first page is received on the paging channel, the out-of-coverage subscriber sends a page response message utilizing the cellular access channel (RACH). Otherwise, if a page is first received from the ad-hoc relay air interface, mobile unit 102 will select the optimal relay to respond through based on the routing protocol. Assuming that it is currently an active slave of the optimal master relay node, the out-of-coverage subscriber unit will then transmit a cellular page response message over the ad-hoc relay link using a ad-hoc relay frame at the prescribed timeslot designated by the master relay node (i.e. only the current master relay node will receive the page response).

When infrastructure equipment 106 receives the page response, it will acknowledge the page response via the RACH (step 609), and when the out-of-coverage subscriber receives the page acknowledgement the procedure is complete (step 611). From this point, a call setup procedure is invoked to place mobile unit 102 on a traffic channel.

Relay Receives Page from Paging Channel for Registered Slave

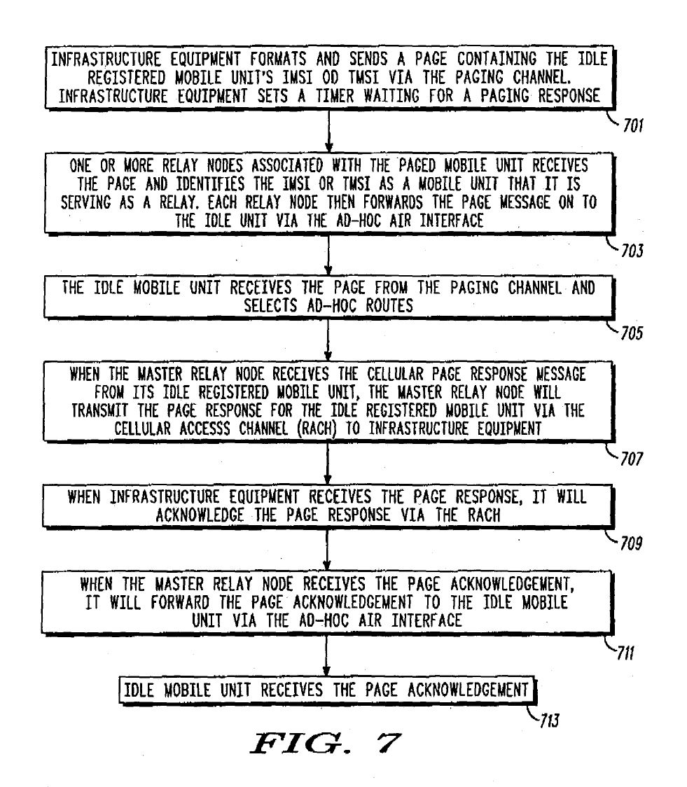

In this scenario, network equipment 106 receives a request to connect an incoming call with a mobile unit that had previously registered the mobile unit's identity (IMSI or TMSI) and associated location area with network equipment 106 as well as with the mobile unit's local ad-hoc network containing one or more relay nodes. The registered mobile unit is in a coverage hole during this scenario. The request to connect will initiate a paging procedure for mobile unit 102. The scenario unfolds as illustrated in FIG. 7.

The logic flow begins at step 701 where infrastructure equipment 106 formats and sends a page containing the out-of-coverage subscriber unit's IMSI or TMSI via the paging channel. Infrastructure equipment 106 sets a timer waiting for a paging response. At step 703 one or more relay nodes monitor a list of IMSI/TMSI in page messages received on the paging channel. When a relay node receives a page containing the identity for an out-of-coverage subscriber unit that was recently or is currently a slave to it, the relay node must then encapsulate the message in a ad-hoc relay signaling frame and send it to the out-of-coverage subscriber unit.

When the out-of-coverage subscriber unit receives the page from one or more of its possible relay nodes via the ad-hoc link, the out-of-coverage subscriber unit will select the optimal relay to respond through based on the routing protocol (step 705). Assuming that it is currently an active slave of the optimal master relay node, the out-of-coverage subscriber unit will then transmit a cellular page response message over the ad-hoc relay link using a ad-hoc relay frame at the prescribed timeslot designated by the master relay node (i.e. only the current master relay node will receive the page response).

When the master relay node receives the cellular page response message from its out-of-coverage subscriber unit, the master relay node will transmit the page response for the out-of-coverage subscriber unit via the cellular access channel (RACH) to infrastructure equipment 106 (step 707). When infrastructure equipment 106 receives the page response, it will acknowledge the page response via the RACH (step 709). When the master relay node receives the page acknowledgement, it will forward the page acknowledgement to the out-of-coverage subscriber via the ad-hoc air interface (step 711). When the out-of-coverage subscriber receives the page acknowledgement (step 713) from the master relay node, then the procedure is complete. From this point, a call setup procedure is invoked to place mobile unit 102 on a traffic channel.

Relay Receives Page from Traffic Channel for Registered Slave

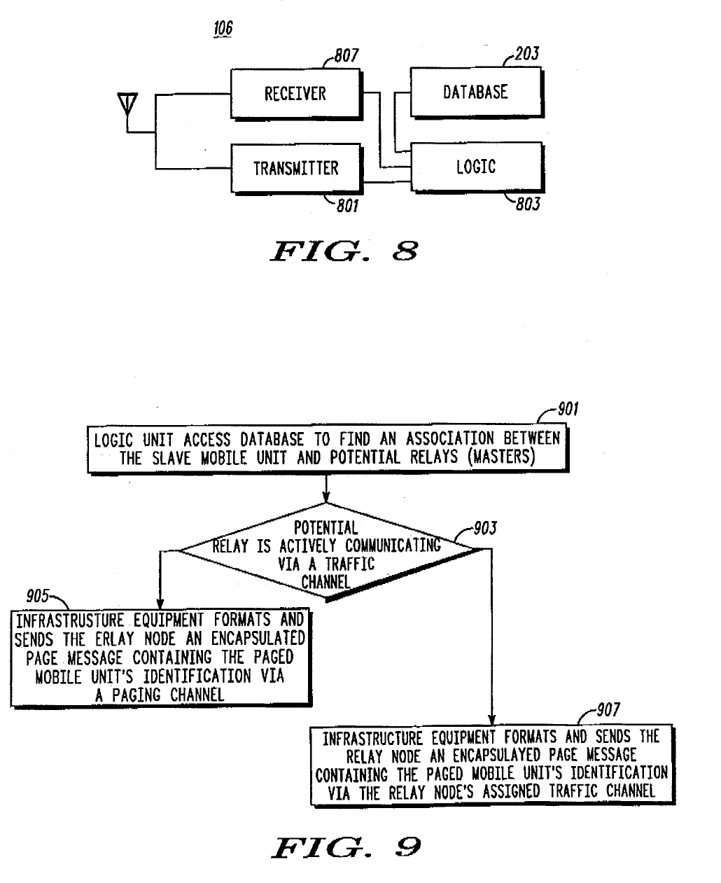

In this scenario, network equipment 106 receives a request to connect an incoming call with a mobile unit that had previously registered the mobile unit's identity and associated location area with network equipment 106 as well as with the mobile unit's local ad-hoc network containing one or more relay nodes. The registered mobile unit is in a coverage hole during this scenario. Additionally, the relay node is currently involved in its own call and therefore has a traffic channel assignment used for signaling and traffic data. This request to connect the incoming call will initiate a paging procedure for mobile unit 102. This scenario provides a solution to the problem where a relay node currently involved in a call provided the only delivery vehicle for a page message to the out-of-coverage subscriber. The scenario is illustrated with reference to FIG. 8 and to FIG. 9.

In the current scenario, infrastructure equipment is receiving messages from a second remote unit (master) relayed through a first remote unit (slave), via an ad-hoc air interface. In the preferred embodiment of the present invention logic unit 803 accesses database 203 to find an association between the slave mobile unit and potential relays (masters) at step 901. Additionally, logic unit determines if the potential relay is actively communicating via a traffic channel (step 903). If, at step 903 logic unit 803 determines that the relay unit is not communicating via a traffic channel, the logic flow continues to step 905 where infrastructure equipment 106 formats and sends the relay node an encapsulated page message containing the paged mobile unit's identification via a paging channel. However, if at step 903 it is determined that the relay unit is actively communicating via a traffic channel, the logic flow continues to step 907 where infrastructure equipment 106 formats and sends the relay node an encapsulated page message containing the paged mobile unit's identification via the relay node's assigned traffic channel.

Infrastructure equipment 106 sets a timer waiting for a paging response. For improved redundancy, infrastructure equipment 106 may also format and send a page containing the out-of-coverage subscriber unit's identification via both the paging channel and the traffic channel. If the out-of-coverage subscriber unit were able to receive the page via the paging channel, it would respond directly to infrastructure equipment 106 with a page response message via the RACH as described above. A page response via a relay node would not be necessary unless the page response was not acknowledged. If one of the out-of-coverage subscriber unit's relay nodes received the page on the paging channel, then the treatment of this page would be as described above.

The above logic flow causes the following events to occur:

1) The relay node receives a page for an out-of-coverage subscriber unit that was recently or is currently one of its slaves. The relay node must then encapsulate the message in a ad-hoc relay signaling frame and send it to the out-of-coverage subscriber unit via the ad-hoc relay air interface.

2) When the out-of-coverage subscriber unit receives the page from its master relay node via the ad-hoc relay link, the out-of-coverage subscriber will transmit a cellular page response message over the ad-hoc relay link using a ad-hoc relay frame at the prescribed timeslot designated by the master relay node.

3) When the master relay node receives the cellular page response message from its out-of-coverage subscriber unit, the master relay node will transmit the page response for the out-of-coverage subscriber unit via its assigned traffic channel to infrastructure equipment 106.

4) When infrastructure equipment 106 receives the page response from the relay's traffic channel, it will acknowledge the page response via the master relay node's traffic channel.

5) When the master relay node receives the page acknowledge, it will forward the page acknowledgement to the out-of-coverage subscriber via the ad-hoc relay air interface.

6) When the out-of-coverage subscriber receives the page acknowledgement from the master relay node, then the procedure is complete. From this point, a call setup procedure is invoked to place mobile unit 102 on a traffic channel (DCH) that is coordinated by the master relay node by either using service multiplexing on the master relay node's existing DCH or by allocating a new DCH.

It should be noted that the above scenario is not limited to situations when mobile units are registering via an ad-hoc air interface. In the preferred embodiment of the present invention infrastructure equipment is constantly determining if information needs to be transmitted to a second remote unit through master remote units. Once that determination is made, the information is transmitted to the master remote units to be relayed to the second remote unit. In the preferred embodiment of the present invention the information is either sent out over a traffic channel if a master is currently utilizing the traffic channel, otherwise the information is sent out over a paging channel. As discussed above, infrastructure equipment will constantly access a database to determine the master relay nodes associated with the second (slave) mobile unit. Information on the traffic channel status of each master mobile is also kept within this database.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for relaying information within an ad-hoc network, the method comprising the steps of:
determining if a first mobile unit has recently been instructed to relay information to/from a second mobile unit;
determining that the first mobile unit will no longer be capable of relaying information to the second mobile unit; and
based on the determination that the first mobile unit has recently been instructed to relay, and additionally based on the determination that the first mobile unit will no longer be capable of relaying information, sending a deregistration message from the first mobile unit to the second mobile unit, causing the second mobile unit to reregister with infrastructure equipment.

2. The method of claim 1 wherein the determination that the first mobile unit will no longer be capable of relaying information to the second mobile unit comprises the steps of determining that the first mobile unit is about to power down.

3. The method of claim 1 wherein the steps of receiving, by the first mobile unit, information, and relaying the information from the first mobile unit to the second mobile unit, comprises the steps of:
receiving information sent from infrastructure equipment to the first remote unit over a cellular air interface; and
transmitting the information from the first remote unit to the second remote unit over an ad-hoc air interface.

4. A method for relaying information within an ad-hoc network, the method comprising the steps of:
receiving a message from a second mobile unit relayed through a first mobile unit via an ad-hoc air interface;
determining that information needs to be transmitted to the second mobile unit;
determining if the first mobile unit is currently utilizing a traffic channel; and
transmitting the information to the first mobile unit to be relayed to the second mobile unit; wherein the information is transmitted over the traffic channel if the first mobile unit is currently utilizing the traffic channel, otherwise the information is transmitted over a paging channel.

5. The method of claim 4 wherein the step of transmitting the information to the first mobile unit to be relayed to the second mobile unit comprises the step of transmitting the information to the first mobile unit over a cellular network to be relayed to the second mobile unit over an ad-hoc air interface.

6. The method of claim 4 further comprising the steps of:
receiving the message from a third mobile unit requesting registration of the second mobile unit;
determining if the third mobile unit is currently utilizing a traffic channel; and
additionally transmitting the information to the third mobile unit to be relayed to the second mobile unit; wherein the information is transmitted over the traffic channel if the third mobile unit is currently utilizing the traffic channel, otherwise the information is transmitted over a paging channel.

7. The method of claim 4 wherein the step of determining if the first mobile unit is currently utilizing the traffic channel comprises the step of accessing a database to determine if the first mobile unit is currently utilizing the traffic channel.

8. A mobile unit comprising:
a receiver having information destined to a second mobile unit as an input;
a transmitter outputting the information to the second mobile unit; and
logic circuitry, determining if the mobile unit is about to power down, and notifying the second mobile unit when the mobile unit is about to power down.

9. The mobile unit of claim 8 wherein the information destined to the second mobile unit is transmitted over a cellular network.

10. The mobile unit of claim 9 wherein the information output to the second mobile unit is output over an ad-hoc network.

11. The mobile unit of claim 8 wherein the logic circuitry additionally determines if information has recently been output to the second mobile unit, and notifies the second mobile unit that is about to power down when information has recently been output to the second mobile unit.

12. Infrastructure equipment comprising:
a receiver receiving a message from a second mobile unit relayed through a first mobile unit via an ad-hoc air interface;
logic circuitry determining that information needs to be transmitted to the second mobile unit, the logic circuitry additionally determining if the first mobile unit is currently utilizing a traffic channel; and
transmitting circuitry outputting the information to the first mobile unit to be relayed to the second mobile unit; wherein the information is transmitted over the traffic channel if the first mobile unit is currently utilizing the traffic channel, otherwise the information is transmitted over a paging channel.

13. The infrastructure equipment of claim 12 wherein the message is received by the receiver over a cellular network.

14. The infrastructure equipment of claim 12 wherein:
the receiver additionally receives a message from a third mobile unit requesting registration of the second mobile unit;
the logic circuitry additionally determines if the third mobile unit is currently utilizing a traffic channel; and
the transmitting circuitry additionally outputs the information to the third mobile unit to be relayed to the second mobile unit; wherein the information is transmitted over the traffic channel if the third mobile unit is currently utilizing the traffic channel, otherwise the information is transmitted over a paging channel.
